(19) United States
(12) Patent Application Publication
(10) Pub. No.: US 2018/0330345 A1
(43) Pub. Date: Nov. 15, 2018

(54) OPTIMIZING PAYMENTS THROUGH A WIRELESS COMMUNICATION SYSTEM

(71) Applicant: Kapil NARANG, Plymouth, MN (US)

(72) Inventor: Kapil NARANG, Plymouth, MN (US)

(21) Appl. No.: 15/591,289

(22) Filed: May 10, 2017

(51) Int. Cl. G06Q 20/10; G06Q 20/32

(52) U.S. Cl. CPC G06Q 20/10; G06Q 20/3224

(57) ABSTRACT

The financial transaction system includes a wireless communications system having at least one data processor. The data processor may automatically select one or more payment means for transmitting a payment term across a wireless network based on the user preferences and user's locale. The financial transaction system may also include a data transmission system for receipt, storage, processing, and transmittal of data across the network.

### FIELD OF THE INVENTION

The systems and methods described, illustrated, and claimed in the present invention relate generally to a wireless communications system that may allow a user to conduct payments across one or more wireless communication networks. More specifically, the wireless communications system allows the user to conduct financial transactions across a network by selecting from one or more payment means.

Further, the present invention relates generally to a method and apparatus for storing, retrieving, and distributing various kinds of data, and more particularly, to an improved database architecture for one or more payment means and method for using the same.

The systems and methods disclosed and claimed in the Parent Application have proven useful in a wide variety of applications and circumstances. The additional embodiments disclosed, illustrated and claimed in the present invention provide a wireless communication system for financial means and automating the selection of a payment means by application of a user's preference for the payment means.

### BACKGROUND

With the advent of wireless technology, the usage of several new and innovative methods have been implemented in the financial transactions which are gaining popularity day by day. Several wireless communication based technologies such as mobile wallets have appeared in recent times that may be installed across wireless devices such a mobile phone or a handheld device. The mobile wallets accept the details of a user's payment means such as, but not limited to, credit cards, debit cards, loyalty cards, other value added cards etc. Upon storing the payment means detail, the user may decide a default payment means that is automatically selected upon every financial transaction until the user changes it manually at the time of the financial transaction. Current paradigms for effecting purchases across a mobile wallet network are limited to use of a single payment means in connection with a purchase.

However, there exists a need for a system to allow the user making payments from a variety of payment means based on logical criteria such location, any coupon offer applicable, varying discount rates and cashback option, and the like. There also exists a need for a system that permits the user to selectively direct payments from one or more payment means by use of a portable, or mobile, wireless communication system commonly in possession of the users worldwide. At least one example of such a portable, or mobile, wireless communications system is a mobile phone, but any wireless communications system to which a data processing system may be operatively connected may be used. In addition, due in part to increasing mobility of people worldwide, and extensive travel, a need exists for a mobile wireless financial device capable of collecting, storing, receiving, and transmitting a wide range of the user financial data, personal information, and business information that may be revised, updated, and provided across a wireless communications system.

The systems and methods disclosed, illustrated, and claimed in the present invention obviate the single payment means automated transaction and offer the prospect of instant payment transactions across a wireless network with the application of several parameters based on user preferences.

### SUMMARY OF THE INVENTION

The systems and methods disclosed herein provide a wireless communications system for conducting financial transactions of a user. In embodiments, a data processor, is operatively connected to the wireless communications system.

In one aspect of the invention, the data processing system includes a plurality of processes for selectively and securely conducting financial transactions using the wireless communications system. In another aspect of the invention, the data processing system is capable of securely receiving, transmitting, and conducting financial transactions across a wireless network. In another aspect of the invention, the data processing system is capable of transmitting and receiving payment instructions in connection a plurality of payment means, across a wireless network. In embodiments, the mobile wireless financial device is also capable of allowing a user of the mobile wireless financial device to receive and transmit a wide variety of financial data across a wireless communications system. In embodiments, the wireless communication system may be a mobile phone, cellular phone, a PDA, and a handheld device, and the like

In embodiments the selected payment means may be but not limited to one or more of credit cards, debit cards, coupons, loyalty cards, and stored offer cards.

The embodiments disclosed, illustrated and claimed in the present invention may provide a wireless communications system for automatically selecting a payment means by including one or more payment decision processes that are responsive to the user's preferences.

### BRIEF DESCRIPTION OF THE DRAWINGS

FIG. 1 is a schematic block diagram illustrating a mobile device employing a wireless communications system

FIG. 2 is a schematic block diagram illustrating a version of the data processing system of the computer associated with the wireless communications system

FIG. 3 is a flow chart illustrating a general use for selecting a payment means

FIG. 4 is a flow chart illustrating one aspect of use of a location determination system for selecting a payment means

FIG. 5 is a flow chart illustrating another aspect of use of a location determination system for selecting a payment means

FIG. 6 is a flow chart illustrating one aspect of use of a date and a time for selecting a payment means

### DETAILED DESCRIPTION OF THE DRAWINGS

The present invention discloses systems and methods for data storage, manipulation and retrieval. Although the present invention is described with reference to specific block diagrams, and flowcharts etc. it will be appreciated by one of ordinary skill in the art that such details are disclosed simply to provide a more thorough understanding of the present invention. The various wireless communication networks include a wireless wide area network (WWAN), a wireless local area network (WLAN), a wireless personal area network (WPAN), and the like. The term “network” and “system” are often used interchangeably. The term “wireless communications network” means a wireless communications system adapted to communicate with one or more mobile wireless communications devices, but also any communications system capable of associating geographical location data with one or more wireless communications devices, a point-of-sale device in a merchant's store, and of transmitting between such geographic locations payment amount pertaining to a commercial transaction involving the sale and purchase of good and/or services, using position-determination technology. The term “payment amount’ includes but not limited to, the amount of a purchase sum or amount, in any vendor-acceptable currency, that the user desires to pay for the products or services of the vendor, any and/or all payment instructions in connection with the payment amount.

The systems and methods discloses a data processor that may be operatively connected to the wireless communications system. In one aspect, the data processor may selectively conduct financial transactions using the wireless communications system. In another aspect, the data processing system is capable of securely receiving, storing, transmitting, and conducting a wide variety of financial transactions across a wireless network. In another aspect, the data processing system is capable of receiving, storing, and transmitting programmable payment instructions in connection with not only one payment means, but in connection with a plurality of payment means.

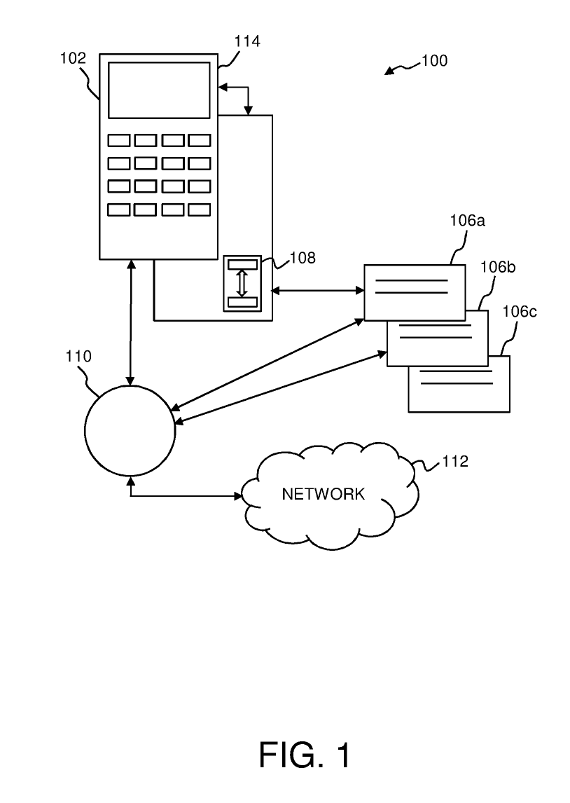

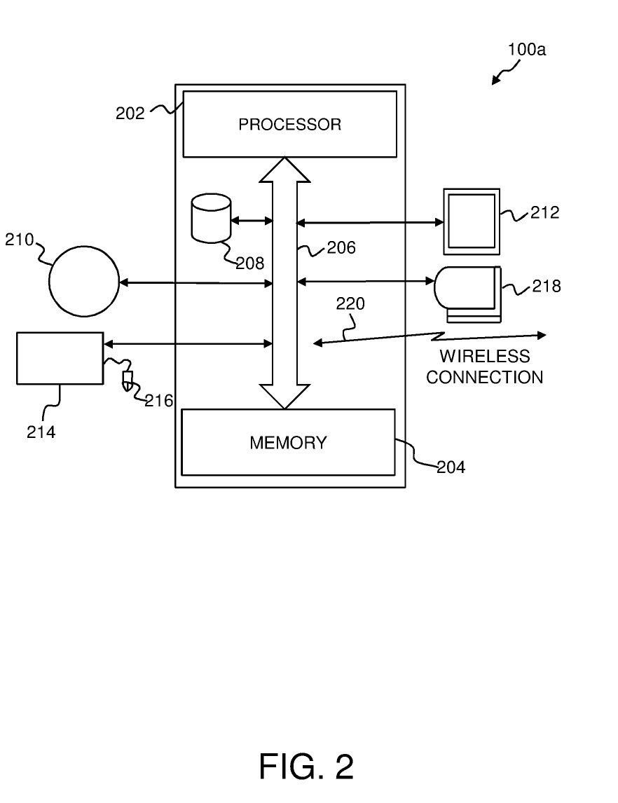

More specifically, in at least one aspect of the systems and methods disclosed, illustrated and claimed in the present invention, a financial transaction system 100 is provided that includes a wireless communications system 102, as illustrated in FIG. 1 schematically and diagrammatically. The wireless communications system 102 may be selected from the group of mobile wireless communications instruments consisting of mobile phones, communication apparatus providing personal communications services including time division multiple access (TDMA), code division multiple access (CDMA) and global system for mobile (GSM), non-voice communication apparatus, text transmission apparatus, satellite telephones, two-way pagers, personal digital assistants, portable wireless computers, a wireless instrument specifically designed to implement financial data transactions, among others. As also illustrated in FIG. 1, the financial transaction system 100 is operatively connected to the portable, or mobile, wireless communications system 102 which may be adapted to transmit and receive payment instructions in connection with one more payment means. In operation, any and all data electronically or otherwise embedded in and on the one or more payment means 106a, 106b, 106c, as shown in FIG. 1, as well as any other data associated with a user is stored in the wireless communications system 102 for use, as further described in the present invention. The wireless communications system 102 includes a data processing system 108 as illustrated in the block diagram of FIG. 2.

As shown, the data processing system 108 may include a variety of components to enable the mobile communications system 102 to send and receive data and information to a financial device 110, including a processor 202, memory 204, the processor and memory connected by a bus 206. The memory 204 is a relatively high-speed machine-readable medium and includes volatile memories such as DRAM, and SRAM, as well as non-volatile memories such as ROM, FLASH, EPROM, EEPROM, and bubble memory. Also connectable to the bus 206 are optional secondary storage 208, an external storage 210, output devices such as a monitor 212 that may be mounted on the wireless communications system 102, in optional configurations an input device such as a keyboard 214 with a mouse 216, and a printer 218. The secondary storage 208 may include machine-readable media such as a hard disk drive, a magnetic drum, and the like. The external storage 210 may include machine-readable media such as a floppy disk, a removable hard drive, a magnetic tape, CS-ROM, and even other computers, possibly connected via a communications line 220. The distinction between secondary storage 208 and external storage 210 is primarily for convenience in describing the invention. As such, a person skilled in the art will appreciate that there is substantial functional overlap between and among the components. The wireless communications system 102 may be capable of communicating with the financial device 110. In operation, the user brings the wireless communications system 102 adjacent the financial devices 110 and, using means for transmitting signals and information, transmits instructions in connection with payment means 106a, 106b 106c to the financial device 110 using wireless communications system 102. As also illustrated in FIG. 1, the financial device 110 is operatively connectable, on demand, to the wireless communications system 102. The financial device 110 is adapted to receive and process payment data. More specifically, the financial device 110 is adapted to receive and process payment data across a wireless network 112 to which the financial device 110 is operatively connectable.

The financial device 110 as illustrated in FIG. 1 also includes one or more processes formulated to be responsive to a user's programmable preferences for payment from the one or more payment means 106a, 106b 106c. The programmable preferences for payment may be presented to and viewed by the user on the wireless communications system 120 as a range of selectable options and/or settings. As with reference to an example, as shown in FIG. 1, a monitor 114 may be mounted on the wireless communications system 102, and the user may scroll through the range of one or more payment options. Further in one embodiment the financial device 110 may allow a user to decide on preferences for making payments from one or more payment means 106a, 106b, 106c. The one or more payment means 106a, 106b, 106c may include, but not limited to, credit cards, debit cards, contactless cards, cash equivalents, offer cards, stored value cards and coupons, and the like. Further, the user may store in the wireless communication system 102 a variety of personal or business financial report. Such reports may be transmitted either across the network 112, to other databases in the discretion of the user. In another aspect of the systems and methods disclosed herein, operatively connected to the mobile wireless communications system 202 is a data processing system 108. A wide array of financial data may be stored in a memory 204 as illustrated in FIG. 2. In addition, the financial transaction system 100 includes both hardware and software operatively connectable to the wireless communications system 102 for securely receiving, transmitting, and concluding the financial transactions across any network of interconnected processors 202.

As indicated, the systems and methods disclosed and in the Parent Application have proven useful in a wide variety of applications and circumstances. The embodiments illustrated in the invention provide a wireless financial system for automatically selecting a payment means 106a, 106b, 106c by including in the wireless communications system 102 by application of one or more payment decision processes for selecting a payment means 106a, 106b, 106c based on the users' preferences for a financial transaction. At least one problem in connection with allowing a consumer to effect payments across the network 112 by charging a payment to one or more payment means 106a, 106b, 106c of a user or owner of the payment means 106a, 106b, 106c are the locations in which a user may seek to use a wireless communication system 102 to effect financial transactions. In addition, the wireless communications system 102 may have a position determination functionality.

As indicated the present invention, and appreciated by a person of skill in the art, the payment means 106a, 106b, 106c and the payment terms that may include information associated with a payment means 106a, 106b, 106c which may be stored in the wireless communications system 102, and used in connection with the one or more payment decision processes to transmit a payment across the network 112. The financial device 110 uses a wireless communication system 102 for automatically selecting a payment means 106a, 106b, and 106c for sending a payment across a wireless communications system 102. In one aspect, the wireless communications system 102 is a mobile phone or a handheld device. However, as a person skilled in the art will appreciate, use of a mobile phone is not a limitation of the wireless communication system 102 for automatically selecting a payment means 106a, 106b, 106c. The wireless communications system 102 has at least the functionality to receive, store, process and transmit a wide variety of financial information. The financial information may include a similarly wide variety of financial data. The location information provided is used to identify among the payment means 106a, 106b, 106c is preferred by the user for a payment amount and term directed to a financial device 110. In another aspect of the wireless communication systems 102 for automatically selecting a payment means 106a, 106b, 106c, as illustrated in FIG. 1, the one or more payment decision processes based on the user preferences of a user of the wireless communications system 102 includes one or more preferences based on the date on which a payment amount is transferred through the financial device 110. In yet another aspect of wireless communication system 102 for automatically selecting a payment means 106a, 106b, 106c as illustrated in FIG. 1, the one or more payment decision processes based on the user's preferences based on the time at which a payment amount is to be transferred across the financial device 110. Another aspect of the wireless communications system for automatically selecting a payment means 106a, 106b, 106c as illustrated in FIG. 1, the one or more payment processes based on the user's preferences of the wireless communications system 102 includes one or more preferences based on prior historical data in connection with use of the one or more payment means 106a, 106b, 106c.

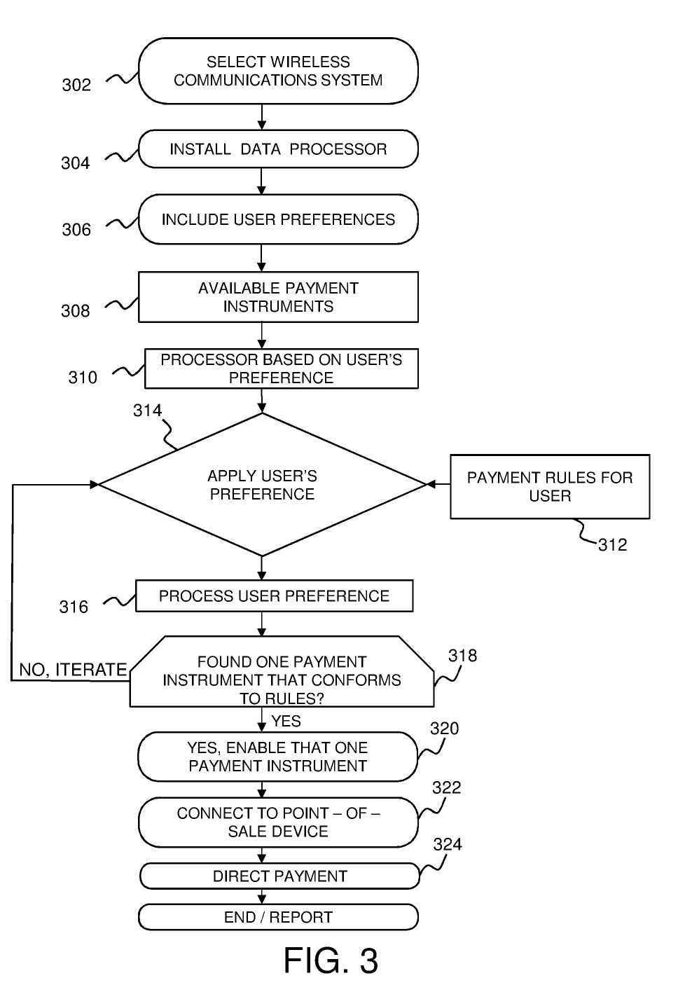

Referring now to FIG. 3, a method of automatically selecting a payment means 106a, 106b, 106c for use in effecting a payment is summarized in a flowchart included as an aid in describing the steps of the method. As shown, the method includes step 302 of selecting a wireless communications system 102. The step 304 recites installing a data processing system 108 in the wireless communications system 102. The Features and capabilities of the data processing system 108 are described in this invention and illustrated by reference to FIGS. 1-2. As also illustrated in FIG. 3, step 306 is directed to installing in the data processing system 108 a selection process. The selection process includes, among other functionalities, a range of possible preferences applicable by a user of the wireless communications system 102 for selecting a single payment means 106 or selecting a payment means 106a, 106b, 106c from among a plurality of payment mean 106a-c. In planning to make purchases, for example, a user of the wireless communications system 102 may identify in step 308 a range of selected preferences from among the range of possible preferences. The range of preferences may include, but are not limited to, one or more credit cards, debit cards, loyalty cards, coupons, stored values, and the like. An order of priority may be established by the user among the preferences in connection with the payment means 106a, 106b, 106c. As a next step 310, the data processing system 108 and the selection processes are shown as operatively connected, and at step 312 the user of the wireless communications system 102 has selected one or more preferences from a menu of the user preferences.

The user, in the example of FIG. 3, has indicated at step 312 a range of preferences for a plurality of payment means 106a, 106b, 106c, and instructed selection of a plurality of payment means 106a, 106b, 106c based on the geographic location of the wireless communications system 102. Thus, in the example illustrated at steps 314 through 318, the one or more payment decision processes is prepared to enable payment from one or more payment means 106a, 106b, 106c based on location of either the wireless communications system 102 and/or the financial device 110. At step 320 the one or more payment decision processes enables the payment when, at step 322, the user operatively connects the wireless communications system 102 and/or the financial device 110. At step 324 the user may authorize the payment amount using any of a number of payment terms acceptable to the financial device 110, and well known to a person skilled in the art. Steps 302 through 324 may be repeated in a subsequent context.

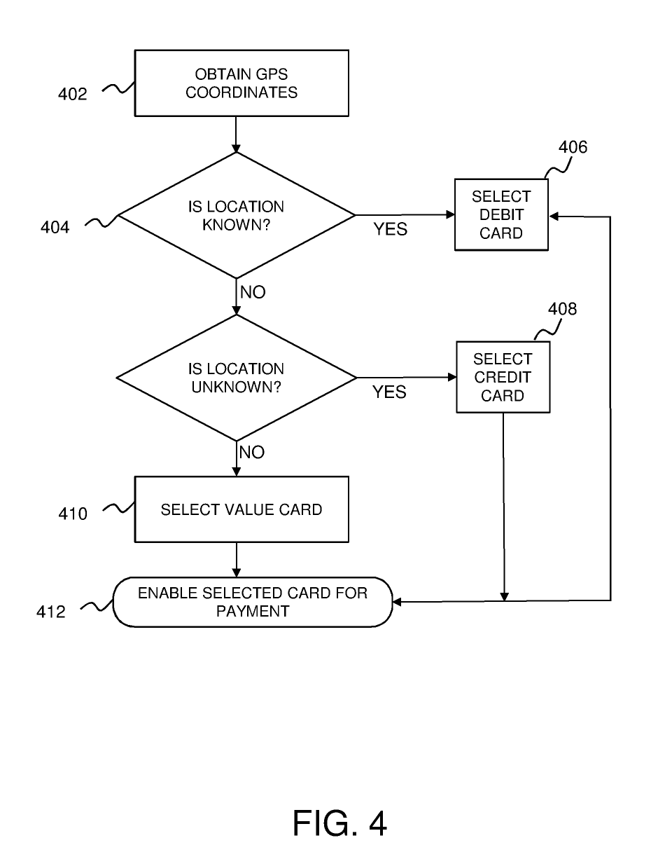

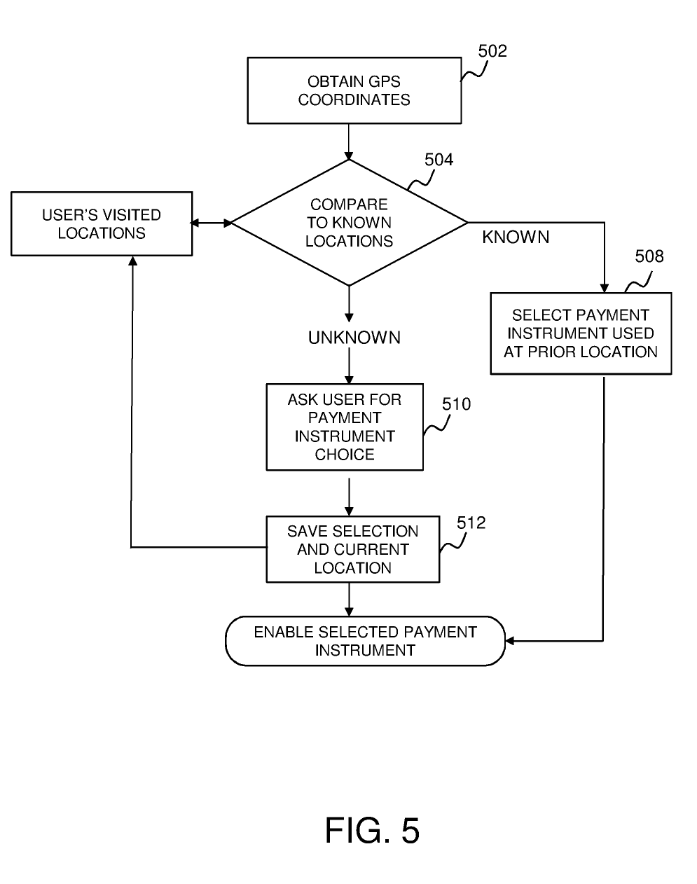

As illustrated in FIG. 4, in one embodiment, an example of the method of automatically selecting a payment means 106a, 106b, 106c for use in effecting a payment may be implemented. At step 402, the location is determined by the financial device 110 is used to determine the coordinates of the wireless communications system 102. Based on the user's preference, the financial device 110 may determine at step 404 that the user wants the method of automatically selecting a payment means 106a, 106b, 106c to be responsive to a location that is prior known and stored in the wireless communications system 102. If that step is satisfied, at step 406 the processes would include alternatively, at step 408, if the user's wireless communications system 102 location is unknown, the selection processes would select, for example, a user's credit card that is a default option for a single means of payment transaction. At step 410, if the selection process determines that the user is at unknown location, the assumption is that the user is traveling hence the selection process would automatically select a default for example, a business credit card. As a person of skill in the art will appreciate, any number of combinations and permutations of location and distance may be used to identify and select from among the range of possible preferences one or more preferences desired by a user for use in a particular context, and to select a payment means 106a, 106b, 106c at step 412. For example, as illustrated in FIG. 1-2 a method of automatically selecting a payment means 106a-c for use in effecting a payment is shown. Moving on to FIG. 5, at step 502, the range of preferences provided by the selection processes would include geographic coordinates of the user's wireless communications system 102.

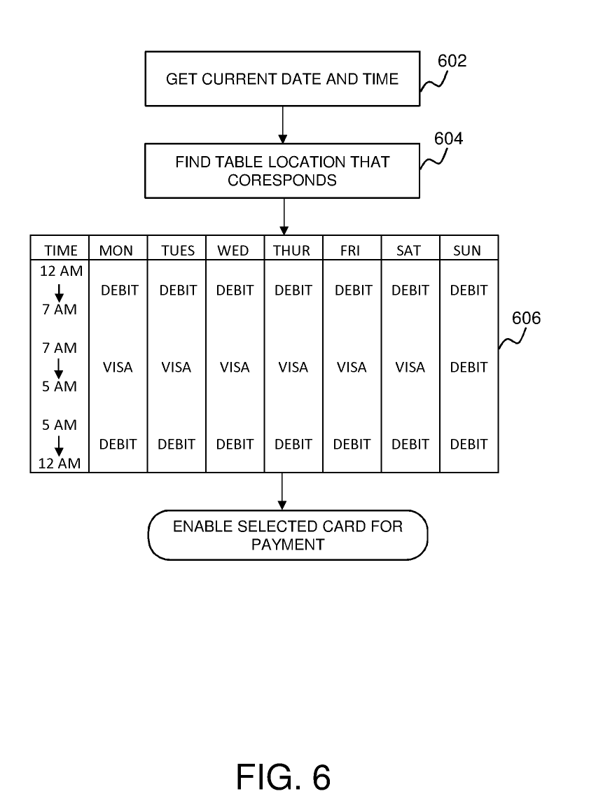

At step 504, one of the range of preferences in the selection process is to compare those coordinates with known locations or, alternatively, at step 506, to determine if the location is an unknown location. If a known location, then at step 508 the selection process would select the same payment means 106a-c used at the same location previously. Alternatively, if the location is unknown, at step 510 the selection process would fetch instructions from the user about a preference for a payment means 106a-c to use. If known or unknown, the location data can automatically be saved in the selection process database of the data processing system 108 as historical data for future use, as shown at step 512. Likewise, as a person skilled in the art will appreciate, the selection process may include the capabilities of ranking preferences in descending order for application to a particular context, matching the ranking of preferences with the particular context, and choosing one or more payment means 106a-c for use in the particular context. In another aspect of the method of substantially automatically selecting a payment means 106a-c for use in effecting a payment, as illustrated in FIG. 6, additional enhancements are achieved by including in the selection process database of the data processing system 108 a range of preferences based on a date and a time of a user's selection of a payment means 106a-c from among the plurality of payment means 106a-c. At step 602 the current data and time are determined. At step 604, the selection process automatically determines, either in combination with location data, or without location data, the preference for a payment means 106a-c. For example, a user may select to use different payment means 106a-c depending on work or non-work hours, a preference that may change, as indicated at step 606, depending on the date of the week.

In yet another embodiment of automatically selecting a payment means 106a-c or use in effecting a payment, additional embodiments are achieved by including in the selection process a range of preferences based on one or more financial parameters chosen by a user for selecting a payment means 106a-c from among the plurality of payment means 106a-c. For example, the selection process database of the data processing system 108 may include a range of preferences based on remaining credit balances associated with a payment means 106a-c. In another embodiment of automatically selecting a payment means 106a-c, wireless communications system 102 is automatically updated with current account information, for example, a card balance.

In yet another embodiment of automatically selecting a payment means 106a-c for use in effecting a payment, the additional embodiments are achieved by including in the selection process a range of preferences based on historical data, location data, and the like

As a person of skill in the art will appreciate, all of the features discussed in this document may be used alone or in combination with one of more preferences of the selection process data. In operation, the unique advantages and features disclosed, illustrated and claimed in this invention are obtained by selecting a wireless communications system. A data processing system is installed in the wireless communications system. The data processing system includes the payment decision algorithm. The payment decision process is responsive to preferences of a user of the wireless communications system including, but not limited to, automatically identifying and selecting a payment means to be used to make a payment amount. Thus, the payment decision process is capable of choosing from among a range of user preferences the unique preferences of a user regarding which payment mean or means to use. Those of skill in the art also will appreciate that the method steps claimed in this invention it can be interchanged and are interchangeable without departing from the scope of the invention. Moreover, although the following disclosure sets forth several embodiments of the invention, other embodiments can have different configurations, arrangements, and/or components than those described herein without departing from the spirit or scope of the present disclosure. For example, other embodiments may have additional elements, or they may lack one or more of the elements described below with reference to FIGS. 1-6.

Those of skill in the art also will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. The previous description of the disclosed aspects is provided to enable any person skilled in the art to make or use the present invention. Various modifications to these embodiments will be readily apparent to those skilled in the art, and the generic principles defined in this invention may be applied to other embodiments without departing from the spirit or scope of the invention. Thus, the present invention is not intended to be limited to the aspects shown in this document, but is to be accorded the widest scope consistent with the principles and novel features disclosed in this invention.

What is claimed is:

1. A wireless communication system comprising:
a data processing unit;
a memory;
a processor coupled to the memory, wherein the processor is configured to perform operations comprising:
sharing data to the data processing unit, receiving data from the data processing unit, and storing the received data, wherein the data is associated with one or more payment means;
uploading information that comprises the location of the wireless communications system; and
identifying at least one payment means that are preferred by a user based on the received location information and one or more preferences of the user.

2. The wireless communications system as claimed in claim 1, wherein the data processing unit transfers information through a wireless network.

3. The wireless communications system as claimed in claim 1, wherein the processor is further configured to make a payment based on the identified one or more payment means.

4. The wireless communications system as claimed in claim 1, wherein identifying one or more payment means that are preferred by the user includes:
at least a date and a time information;
a historical data in connection with use of the one or more payment means; and
a user experience of the one or more payment means.

5. The wireless communications system as claimed in claim 1, wherein the identified one or more payment means comprise one or more of credit cards, debit cards, coupons, loyalty cards, and stored offer cards.

6. The wireless communications system as claimed in claim 1, wherein the processor is further configured to perform operations comprising recording the location of the wireless communications system.

7. The wireless communications system as claimed in claim 1, wherein the wireless communications system is a mobile phone, a cellular phone, a PDA, and a handheld device.

8. The wireless communications system as claimed in claim 1, wherein the device comprises one or more of a point-of-sale device, a credit card reader, a debit card reader, and an automated teller machine.

9. A method comprising:
receiving information for a location of a wireless device;
selecting one or more user preferences from one or more user preferences stored in the wireless device; and
deciding one or more payment means based on the selected one or more user preferences and the received location information.

10. The method as claimed in claim 9, further comprising transmitting data from the wireless communications system to a device across a wireless communications network, wherein the data identifies the selected one or more payment means.

11. The method as claimed in claim 9, wherein the transmitted data comprises of a process of making a payment from the one or more payment means.

12. The method as claimed in claim 9, wherein selecting one or more payment means comprising of:
identifying the received location information;
using the selected one or more user preferences; wherein the user preferences includes:
at least a date and time information;
a historical data in connection with use of the one or more payment means and;
a user ranking of the one or more payment means.

13. The method as claimed in claim 9, wherein the selected one or more payment means comprise one or more of credit cards, debit cards, coupons, loyalty cards, and stored offer cards.

14. The method as claimed in claim 9, further comprising recording the location of the wireless communications system.

15. The method as claimed in claim 9, wherein the wireless communications system is a mobile phone, a cellular phone, a PDA, and a handheld device.
